(19) United States
(12) Patent Application Publication
(10) Pub. No.: US 2026/0250954 A1
(43) Pub. Date: Aug. 27, 2026

(54) VERY SEVERE HAIL ROOF BOARD

(71) Applicant: United States Gypsum Company, Chicago, IL (US)

(72) Inventors: Michael Patrick SHAKE, Johnsburg, IL (US); Michael Joseph HOUGH, Beach Park, IL (US)

(21) Appl. No.: 19/308,618

(22) Filed: Aug. 25, 2025

Related U.S. Application Data
(60) Provisional application No. 63/762,757, filed on Feb. 25, 2025.

(51) Int. Cl. E04D 3/18; B28B 19/00; E04D 3/40

(52) U.S. Cl. CPC E04D 3/18; B28B 19/0092; E04D 3/40

(57) ABSTRACT

Building construction materials and methods, including impact-resistant gypsum roof boards having a gypsum core comprising glass fibers and paper fibers, the gypsum core being extruded between fiber mats, preferably the gypsum roof boards being VHS (very severe hail) rated, for use in roof decks with improved resistance to hail damage, and methods of manufacturing and using the impact-resistant gypsum roof boards.

### CROSS-REFERENCE TO RELATED APPLICATIONS

This application claims the benefit of priority to U.S. provisional patent application 63/762,757 filed Feb. 25, 2025, the entire disclosure of which is herein incorporated in its entirety.

### TECHNICAL FIELD

This disclosure relates to building construction materials and methods, including impact-resistant roof boards for use in roof decks with improved resistance to hail damage, and methods of manufacturing and using the impact-resistant roof boards.

### BACKGROUND

Hail can damage roofs, especially in geographic locations known to have severe hailstorms. Thus, there exists a need for roof boards with improved resistance to hail impact. In particular, there is a need for impact-resistant roof boards that may meet or exceed requirements of the Factory Mutual (FM) 4470 very severe hail (VSH) standard under which a roof board, when tested in a roof deck assembly, should withstand without cracking an impact energy of 53-58 ft-lb (72-79 J) applied to a surface of the roof deck assembly.

In order to improve impact resistance, some roof decks may be built with plywood boards which are generally not fire resistant, unless additional chemicals are applied. Thus, there remains the need in the field for a roof board that will be impact-resistant and also fire-resistant. Gypsum panels are known to be fire-resistant, and they can be used for building interior or exterior walls, including as described in U.S. Pat. Nos. 10,562,271, 11,780,113, 11,999,658 and U.S. publication 2024/0182363. United States Gypsum Company has previously commercialized gypsum panels rated as abuse-resistant and which contain either a fiberglass scrim or a combination of glass fibers and wood fibers for interior applications. Certain gypsum panels are known for building roof deck assemblies, including as described in U.S. Pat. Nos. 11,111,174 and 10,486,388 and U.S. Patent Publication 2024/0359429.

Various attempts have been made to improve resistance of a gypsum panel to impacts, including by incorporating a fiberglass scrim, as described in U.S. patent publication 2012/0148806, U.S. Pat. Nos. 10,562,271 and 11,643,817. However, there remains the need in the field for impact-resistant gypsum roof boards and in particular gypsum roof boards which can meet the Factory Mutual 4470 very severe hail (VSH) standard.

### SUMMARY

Objectives of this disclosure include to provide an impact-resistant gypsum roof board and roof deck assemblies built with the roof boards. Preferably, at least some gypsum roof board embodiments meet or even exceed requirements of the FM 4470 VSH standard. It is a further objective of this disclosure to provide methods and roof deck assemblies that can be useful for building roofs with improved resistance to hail damage, including in geographic locations known to have severe hailstorms.

In one aspect, this disclosure provides a gypsum roof board for use in a roof deck,
wherein the gypsum roof board has a length, width and thickness, two long surfaces, a first long surface and a second long surface which is opposite to the first long surface,
wherein the gypsum roof board comprises a gypsum core covered on the first long surface with a facer fiber mat, said gypsum core further covered on the second long surface with a backer fiber mat,
wherein the gypsum roof board weighs at least about 2.9 pounds per square foot (lbs/SF) when the gypsum roof board has the thickness of ⅝ inch; and
wherein the gypsum core comprises a set gypsum matrix into which paper fibers and glass fibers are embedded.

Preferably, the gypsum core does not comprise fiberglass scrim. In some preferred embodiments, the gypsum roof board may weigh about 3-4 lbs/SF when the gypsum roof board has the thickness of ⅝ inch. Preferably, the gypsum roof board may withstand without cracking an impact with impact energy of 53-58 feet per pound (72-79 J) applied to a surface of a roof deck containing the gypsum roof board, including the impact which may be caused by propelling at the surface a preformed 2-inch (51 mm) diameter ice ball, wherein the ice ball is propelled with a velocity of 152 to 160 feet per second.

The gypsum roof board may be moderate hail (MH) rated, severe hail (SH) rated and/or very severe hail (VSH) rated, each rating in accordance with FM 4470.

In some preferred embodiments, the gypsum roof board may be made from a gypsum slurry comprising:
calcined gypsum in an amount ranging 2.1-3.0 lbs/SF for a ⅝ inch thick gypsum roof board;
glass fibers in an amount of 0.4-1.0 wt/% by weight of the calcined gypsum;
paper fibers in an amount of 0.4-1.0 wt/% by weight of the calcined gypsum;
pregelatinized starch in an amount of 0.1-1.0 wt % by weight of the calcined gypsum;
acid-modified starch in an amount of 0.1-1.0 wt % by weight of the calcined gypsum;
an activator comprising ground calcium sulfate dihydrate in an amount of 0.1-1.0 wt % by weight of the calcined gypsum;
one or more of the following compounds: diethylenetriamine pentaacetic acid (DTPA), citric acid, sodium citrate, potassium bitartrate, or any combination thereof in an amount of 0.01-0.5 wt % by weight of the calcined gypsum; and
wherein the gypsum slurry further comprises water; and
wherein a water-to-stucco weight ratio (WSR) in the gypsum slurry is in the range from 0.5 to 1.2.

In some preferred embodiments, the gypsum slurry may further comprise fluid polymerizable siloxane, and one or more of the following compounds: fly ash, Magnesium Oxide or any combination thereof.

At least in some embodiments, the gypsum slurry may further comprise:
a phosphate compound;
a buffering agent;
a biocide; and/or
a polycarboxylic dispersant, sulfonate dispersant, or a combination of the polycarboxylic dispersant and sulfonate dispersant.

In some embodiments, the gypsum slurry may be foamed with foam comprising a combination of first foaming agent and a second foaming agent, wherein
the first foaming agent has the following formula:

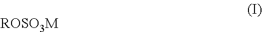

Wherein R is an alkyl chain having from 2 to 20 carbon atoms and M is a cation; and
the second foaming agent having the following formula:

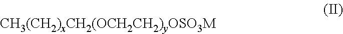

X is a number from 2 to 20, and Y is a number from 0 to 10 and is greater than 0 in at least 50 weight percent of the second foaming agent.

In some embodiments, the gypsum core may contain air voids. In some embodiments, the paper fibers may comprise old corrugated container (OCC) paper fibers.

In some embodiments, the length value of the gypsum roof board may be substantially equal to the width value.

In some embodiments, the gypsum roof board may further comprise an adhesive layer on the first long surface, the adhesive layer positioned between the facer fiber mat and the gypsum core, wherein the adhesive layer may be formed from a gypsum slurry which is not mixed with foam.

In embodiments of the gypsum roof board, the facer fiber mat may be a coated glass fiber mat and/or the backer fiber mat may be an uncoated glass fiber mat.

In another aspect, this disclosure relates to a roof deck assembly comprising the gypsum roof board according to this disclosure, the roof deck having the gypsum roof board with the second long surface being attached to an insulation layer and the gypsum roof board overlayed on the first long surface with a waterproof membrane, wherein the gypsum roof board in the roof deck withstands without cracking on the second long surface an impact with impact energy of 53-58 feet per pound (72-79 J) applied to a waterproof membrane surface of the roof deck.

In some embodiments, the waterproof membrane may comprise an ethylene propylene diene monomer (EPDM) rubber membrane, thermoplastic polyolefin (TPO) membrane, polyvinyl chloride (PVC) membrane, ketone ethylene ester (KEE) membrane, or any combination thereof.

In embodiments of the roof deck, the gypsum roof board may be moderate hail (MH) rated, severe hail (SH) rated and/or very severe hail (VSH) rated, each rating in accordance with FM 4470. In some embodiments of the roof deck, the waterproof membrane may comprise a polyester scrim.

Embodiments of the roof deck include those, wherein:
the insulation layer is composed of a polyisocyanurate rigid foam boards;
the insulation layer is bonded to the gypsum roof board with a polyurethane-based adhesive; and/or
the waterproof membrane is adhered to the gypsum roof board with asphalt, epoxy, or polyurethane adhesive.

In some preferred embodiments, the waterproof membrane may have a thickness from 30 to 100 mils.

In yet another aspect, this disclosure relates to a method of manufacturing the gypsum roof board according to this disclosure, wherein the method comprises:
a) mixing a gypsum slurry comprising at least:
   calcined gypsum in an amount ranging 2.1-3.0 lbs/SF for a ⅝ inch thick gypsum roof board;
   glass fibers in an amount of 0.4-1.0 wt/% by weight of the calcined gypsum;
   paper fibers in an amount of 0.4-1.0 wt/% by weight of the calcined gypsum;
   pregelatinized starch in an amount of 0.1-1.0 wt % by weight of the calcined gypsum;
   acid-modified starch in an amount of 0.1-1.0 wt % by weight of the calcined gypsum;
   an activator comprising ground calcium sulfate dihydrate in an amount of 0.1-1.0 wt % by weight of the calcined gypsum;
   one or more of the following compounds: diethylenetriamine pentaacetic acid (DTPA), citric acid, sodium citrate, potassium bitartrate, or any combination thereof in an amount of 0.01-0.5 wt % by weight of the calcined gypsum; and
   wherein the gypsum slurry further comprises water; and
   wherein a water-to-stucco weight ratio (WSR) in the gypsum slurry is in the range from 0.5 to 1.2;
b) depositing the gypsum slurry on the facer fiber mat;
covering the deposited gypsum slurry with the backer fiber mat to form a gypsum roof board precursor;
c) cutting the gypsum roof board precursor into gypsum roof boards; and
d) drying the gypsum roof boards of step c) in kiln; and
e) optionally, cutting each gypsum roof board of step d) into two gypsum roof boards.

### BRIEF DESCRIPTION OF THE DRAWINGS

FIG. 1A is a perspective view of one embodiment of a gypsum roof board according to this disclosure.

FIG. 1B is a fragmentary cross-sectional view along the longitudinal axis (L) of the gypsum roof board of FIG. 1A.

FIG. 2 is a fragmentary cross-sectional view of one embodiment of a roof deck built with the gypsum roof board according to this disclosure.

### DETAILED DESCRIPTION

In this disclosure, “wt %” means percentage by weight. In this disclosure, all percentages and ratios are by weight, unless specifically stated otherwise.

In this disclosure, “lbs/MSF” refers to pounds per one thousand square feet and “lbs/SF” refers to pounds per square foot.

In this disclosure, “dry component” means a component which does not comprise aqueous water or liquid additives. The dry component may have some moisture content and may contain bound water molecules.

In this disclosure “by wt % on a dry basis of the composition” means by weight of dry components, not including aqueous water or liquid components.

In this disclosure, measurement units may include a foot (30.48 centimeters) which may be abbreviated as “′” and inch (2.54 centimeters) which may be abbreviated as “′”.

In this disclosure, the term “gypsum” may refer to any of the following: naturally mined gypsum (ore), landplaster and/or synthetic gypsum. Gypsum may also include gypsum which originates from a waste stream, as a bi-product, or a recycled material, such as dry wall. The term “gypsum” may be used interchangeably with the term “calcium sulfate dihydrate” or CaSO₄·2H₂O.

The term “synthetic gypsum” can be also referred to as “chemical gypsum,” or flue gas desulfurization (FGD) gypsum.

In this disclosure, the term “calcined gypsum” may be used interchangeably with calcium sulfate hemihydrate, stucco, calcium sulfate semi-hydrate, calcium sulfate half-hydrate, plaster of Paris, or CaSO₄·½H₂O. Calcined gypsum may further comprise some calcium sulfate (CaSO₄).

When calcined gypsum (CaSO₄·½H₂O) is mixed with water into a slurry or paste, calcined gypsum hydrates and sets into a gypsum matrix. This setting reaction can be described by the following equation:

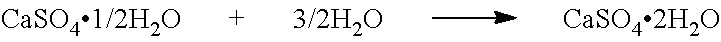

In this disclosure, the FM 4470 VSH test refers to Factory Mutual 4470 test for resistance to very severe hail damage.

In this disclosure, “about” means plus/minus 10% of a specified numeric value, e.g., “about 100” means 100±10 and “about 200” means 200±20.

In this disclosure, the water-to-stucco ratio can be abbreviated as the WSR.

In one aspect, this disclosure relates to an impact-resistant gypsum roof board addressing several technical problems, including that conventional gypsum roof boards fail to pass the FM 4470 VSH test. It has been unexpectedly found that a particular formulation of a gypsum core which preferably does not comprise fiberglass scrim is suitable for gypsum roof boards useful in roof decks with improved resistance to hail damage, preferably the roof decks capable of withstanding an impact with energy of 53-58 ft-lb (72-79 J) without substantial damage to the gypsum roof boards.

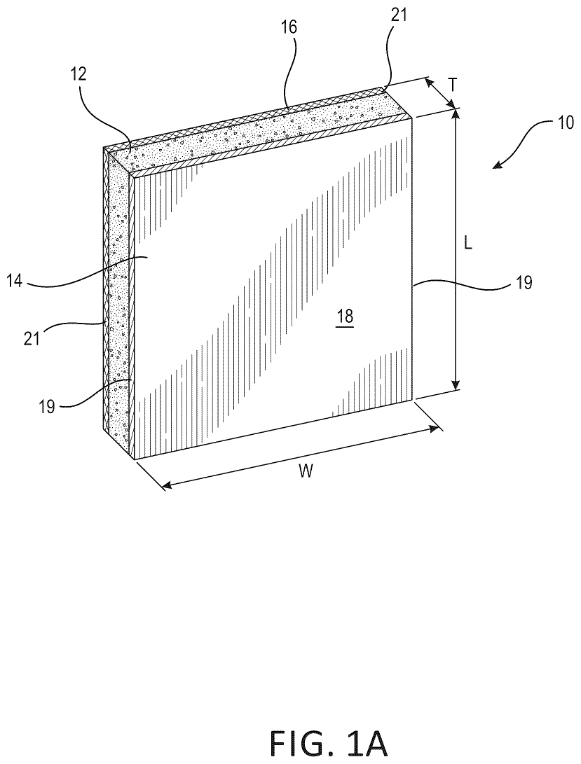

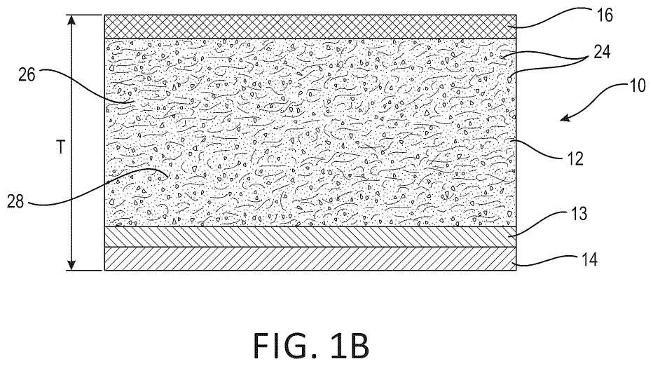

Referring to FIGS. 1A (perspective view) and 1B (a fragmentary cross-sectional view along the machine direction axis (L) of FIG. 1A), one embodiment of the gypsum roof board according to this disclosure is shown, generally (10).

The gypsum roof board (10) comprises a gypsum core (12) extruded between a facer fiber mat (14) and a backer fiber mat (16). The gypsum roof board (10) has a length (L), width (W) and thickness (T). The length (L) may be preferably the same as the width (W) and the width (W) may be preferably greater than the thickness (T). In some embodiments, the length (L) may be greater than the width (W).

The gypsum roof board (10) has two long surfaces. A first long surface (18) is defined between the machine direction length (L) and the cross-machine width (W), and two machine direction edges (19, 19). The first long surface (18) is covered with the facer fiber mat (14). Its opposite second long surface (20) (not visible in FIG. 1A) is covered with the backer fiber mat (16) and it has the length (L) and the width (W), and two machine-direction edges (21, 21). In embodiments, the long surfaces (18) and (20) may be of square or rectangular shape.

In some preferred embodiments, the gypsum roof board may have the length (L) and/or the width (W) of about 4 feet. The 4′×4′ boards may be of different thickness, preferably having the thickness (T) of about ⅝ inch, and more preferably weighing about 50 pounds. The 4′×4′ dimension may speed up roof installation in part because the boards are less heavy than 8′×4′ boards and also because having a board with substantially square long surfaces may permit for installing a gypsum roof board layer without the need to align boards' machine direction edges.

However, gypsum roof boards according to this disclosure may be made in other dimensions as well, including when the length (L) of the board is greater than its width (W), e.g. 5′×4′, 6′×4′, 7′×4′ or 8′×4′ boards.

In some embodiments, the facer fiber mat (14) and the backer fiber mat (16) may be the same. However, preferably, the facer fiber mat (14) may be coated, while the backer fiber mat (16) may be uncoated, as discussed in more detail below. The gypsum roof board (10) may be manufactured of various length (L), width (W) and thickness (T), but preferably the gypsum roof board (10) may have the thickness (T) of ⅝ inches.

The gypsum core (12) comprises a set gypsum matrix (22) into which various additives, including additives (26 and 28) are incorporated. The gypsum core (12) may be produced by mixing an aqueous slurry comprising calcined gypsum and other additives and then depositing the gypsum slurry on the facer fiber mat (14), covering the disposed gypsum slurry with the backer fiber mat (16), and allowing the calcined gypsum in the gypsum slurry to hydrate and set into the set gypsum matrix of the gypsum core (12).

In some embodiments, the gypsum core (12) may be adhered directly to fiber mats (14 and 16). In other embodiments, the gypsum roof board (10) may include an adhesive layer or coating (13) positioned between the gypsum core (12) and the fiber mat (14), as shown in FIG. 1B, and/or a second adhesive layer or coating similar or different from the layer (13) (not shown in FIG. 1B) and positioned between the gypsum core (12) and the fiber mat (16).

The adhesive layer or coating (13) may be composed of a set gypsum matrix with a density higher than that of the gypsum core (12). In embodiments, the adhesive layer (13) may be prepared from the same or substantially the same gypsum slurry as used for preparing the gypsum core (12), but without foaming such that the adhesive layer (13) comprises only very few air voids in comparison to the gypsum core (12) which may be foamed and thus include air voids (24) in at least some embodiments.

It has been unexpectedly found that a gypsum roof board with acceptable impact resistance for use in a hail-resistant roof deck can be obtained by formulating a gypsum slurry according to this disclosure. The technical solution according to this disclosure includes producing a gypsum roof board which is heaver and may weigh in some preferred embodiments at least about 2.9 or more pounds per square foot (lbs/SF) when the roof board has the thickness of ⅝ inch. Preferably, the gypsum roof board (10) may weigh in the range of about 2.9-4 lbs/SF, more preferably 3-3.5 lbs/SF and most preferably 3.1-3.5 lbs/SF, when the roof board (10) has the thickness of ⅝ inch. The gypsum roof boards of other thickness (T), e.g. 1 inch, can be also made.

Preferably, the weight of the gypsum roof board (10) is increased by increasing amounts of calcined gypsum in a gypsum slurry from which the gypsum core (12) is made, but may be also achieved by increasing amounts for other components as well. Previously, it was believed that increasing amounts of calcined gypsum may result in an increased viscosity of a gypsum slurry such that it may be difficult to produce a gypsum board continuously in part because of premature and uneven hydration and setting of calcined gypsum in viscous gypsum slurries. However, in present gypsum slurry formulations according to this disclosure, this technical difficulty has been addressed by incorporating into a gypsum slurry a particular combination of additives, as described in more detail below.

A first necessary component in a gypsum slurry for forming the gypsum core (12) is calcined gypsum which can be used in any suitable amount, but preferably in an amount of at least about 2.1 lbs/SF lbs/SF of calcined gypsum in a ⅝ inch thick gypsum roof board, and more preferably in an amount in the range 2.1-3.0 lbs/SF for ⅝ inch thick gypsum roof boards, and most preferably in an amount in the range 2.4-2.9 lbs/SF for ⅝ inch thick gypsum roof boards. If a gypsum roof board is made of different thickness, e.g. of 0.5 inch or 1 inch, the amount of calcined gypsum and some or all additives may be decreased or increased proportionally to a decrease or increase in the gypsum board thickness.

A second necessary component in the gypsum core (12) is a combination of glass fibers and paper fibers. It has been unexpectedly found that both types of fibers are necessary in order to achieve the preferred impact-resistance in the gypsum roof board.

Glass fibers of various length and diameter can be used, including glass fibers, preferably e-glass fibers, of about 0.4 to about 0.8 inches in length and/or having a diameter of about 10 to about 20 microns. It also has been unexpectedly found that in order to achieve the impact-resistant property of the gypsum roof board, glass fibers are preferably used in an amount of at least 0.4 wt % by weight of the calcined gypsum, more preferably in the range of about 0.4-1.0 wt % by weight of the calcined gypsum, and most preferably in the range of about 0.4-0.5 wt % by weight of the calcined gypsum.

The gypsum core (12) may comprise glass fibers in combination with paper fibers, preferably recycled paper fibers. Preferably, paper fibers may contain old corrugated container (OCC) fibers which may be supplied from gypsum board back paper (Newsline) and/or from recycled corrugated cardboard material used in packaging and shipping boxes. Corrugated paper fibers can be produced by pulping up corrugated paper and/or gypsum board backer paper which is composed of OCC fibers, or by processing the paper through a hammer mill. In some embodiments, paper fibers may include Manila paper fibers which can be obtained by pulping gypsum facer paper. In embodiments, Manila paper may comprise about 1/3 parts by weight recycled newsprint grade fibers and 2/3 parts by weight of OCC fibers. Other suitable paper grades of paper fibers may include, but are not limited to, newsprint grade paper, Kraft paper, duplex paper, ivory paper, or any combination thereof. In embodiments, paper fibers may include OCC fibers, newsprint grade fibers, or any combination thereof. In embodiments paper fibers may include paper fibers obtained by pulping or milling the Newsline grade paper which is composed of old corrugated container (OCC) fibers and/or Manila grade paper composed of recycled newsprint grade fibers and OCC fibers.

It also has been unexpectedly found that in order to improve the impact-resistant property of the gypsum roof board, paper fibers are preferably used in an amount of at least 0.4 wt % by weight of the calcined gypsum, more preferably in the range of about 0.4-1.0 wt % by weight of the calcined gypsum, and most preferably in the range of about 0.4-0.5 wt % by weight of the calcined gypsum.

Gypsum slurries may further comprise at least one binder which may include a latex binder, including vinyl acrylate, methyl methacrylate and butyl acrylate binders, one or more starch binders, or any combination thereof.

Preferably, the gypsum slurry may comprise a binder comprising one or more starches. At least one of the starches may be pregelatinized by being mixed with water and heated (cooked) until it thickens into a gel. A particularly preferred starch is corn starch, but other starches, such as wheat, tapioca and/or potato starch may be also used. Preferably, a combination of two starches may be used in which a first starch, which is preferably corn starch, is pregelatinized. In some preferred embodiments, the first pregelatinized starch may be used in an amount ranging from about 0.1 to about 1.0 wt %, and more preferably from about 0.1 to about 0.5 wt % by weight of the calcined gypsum.

A second starch in the starch binder combination may be preferably chemically or enzymatically modified. Suitable modified starches include, preferably corn, wheat, tapioca or potato starch, and most preferably corn starch. A preferred modification is acid-modified starches which are obtained by partially hydrolyzing a starch with an acid, preferably an inorganic acid, in order to increase fluidity of the starch. Typically, a starch is a polymer composed of a repeating glucose unit (C₆H₁₀O₅), and having an average molecular weight of about 10,000,000 Daltons. An acid-modified starch has a decreased molecular weight which may be averaging as low as 10,000 Daltons. Other methods for partially hydrolyzing starch, e.g. enzymatic or by extrusion, can be also used.

An acid-modified starch may be used in any suitable amounts, but preferably the acid-modified starch may be used an amount ranging from about 0.1 to about 1.0 wt %, and more preferably from about 0.1 to about 0.5 wt % by weight of the calcined gypsum.

In order to improve water resistance of the gypsum roof boards, a gypsum slurry may comprise polymerizable siloxane emulsion which may further include one or more emulsifiers. Preferred siloxanes may include a fluid polymerizable siloxane comprising a repeating unit (R₂SiO)ₙ, wherein each of the two Rs independently represents a saturated or unsaturated mono-valent hydrocarbon radical or hydrogen. Most preferred siloxanes include, but are not limited to, an alkyl hydrogen siloxane such as for example, as methyl-hydrogen siloxane. Gypsum slurries may comprise from about 0.1 to about 1 wt % and more preferably from about 0.1 to about 0.5 wt % polymerizable siloxane emulsion by weight of the calcined gypsum.

In order to improve polymerization of siloxane, the gypsum slurries may further comprise small amounts of one or more of the following compounds: fly ash, preferably Class C fly ash, magnesium oxide, preferably dead-burned magnesium oxide, based on U.S. Pat. Nos. 7,892,472 and 7,803,226. In preferred embodiments, the gypsum slurries may comprise from about 0.1 to about 1.0 wt % class C fly ash and/or from about 0.01 to about 0.1 wt % Magnesium Oxide by weight of the calcined gypsum.

Since gypsum slurries according to this disclosure contain high amounts of calcined gypsum, it was found that it is technologically advantageous to include a combination of setting reaction modifiers.

A setting reaction modifier may include at least one activator of calcined gypsum setting reaction. Such activators may include one or more of the following: potassium sulfate, land plaster, ground calcium sulfate dihydrate, calcium sulfate dihydrate co-ground with sugar (“CSA”), and/or calcium sulfate dihydrate co-ground with sugar and then heat-treated as described in U.S. Pat. No. 2,078,199 (“HRA”). The setting reaction activator may be used in any suitable amount, and preferably in an amount ranging from about 0.1 to about 1.0 wt %, and more preferably in an amount ranging from about 0.1 to about 0.5 wt % by weight of the calcined gypsum.

The gypsum slurries may further include one or more of phosphate compounds which may be composed of two or more phosphate residues, including trimetaphosphate salts, preferably sodium trimetaphosphate (STMP), potassium trimetaphosphate, and/or ammonium trimetaphosphate. Other suitable phosphate compounds may include tetrapotassium pyrophosphate and sodium tripolyphosphate.

The phosphate compounds can be used in a small amount, preferably from about 0.1 to about 1.0 wt % by weight of the calcined gypsum, and more preferably from about 0.1 to about 0.5 wt % by weight of the calcined gypsum.

The gypsum slurries may further include one or more agents that delay a hydration reaction of calcined gypsum. Preferably, these compounds may include calcium chelators and may include any of the following compounds: diethylenetriamine pentaacetic acid (DTPA), citric acid, sodium citrate, potassium bitartrate, or any combination thereof.

The calcium chelator can be used in a small amount, preferably in an amount ranging from about 0.1 to about 1.0 wt % by weight of the calcined gypsum, and more preferably from about 0.1 to about 0.5 wt % by weight of the calcined gypsum.

The gypsum slurries may further include one or more dispersants, preferably a polycarboxylate or sulphonate dispersant. Particularly preferred sulphonate dispersants may include naphthalene sulphonate compounds, including polymeric condensation products of naphthalene sulfonic acid and formaldehyde, with particularly preferred poly naphthalene sulfonates, including sodium or calcium salts, and having an average molecular weight ranging from about 3,000 to about 27,000 Daltons.

At least in some embodiments, a sulfonate dispersant may comprise a lignosulfonate which is a polymeric by-product of a wood pulp production method using sulfite for pulping.

Suitable polycarboxylate dispersants may include polycarboxylic ethers having a molecular weight ranging from about 20,000 to about 50,000 Daltons, including as described in U.S. Pat. No. 7,767,019, as well as polycarboxylate dispersants described in U.S. Pat. No. 6,777,517 or U.S. Pat. No. 5,798,425.

The dispersant may be helpful in decreasing water demand and improving homogeneous mixing of calcined gypsum with water. If present, the dispersant may be used in a small amount, preferably in an amount ranging from about 0.4 to about 5 wt %, and more preferably from about 0.4 to about 1.0 wt % by weight of the calcined gypsum.

In some embodiments, the gypsum slurry may further comprise a buffering agent and/or biocide, one example of which may be boric acid which can be used in small amounts, for example from about 0.01 to about 0.1 wt/% by weight of the calcined gypsum, if present.

Other optional additives may include one or more of the following compounds: coloring agents, clay, cellulosic thickener, cement, vermiculate, calcium carbonate, perlite, glass bubbles and/or other natural or synthetic fillers and thickeners. These compounds may be used in any suitable amounts, for example at least about 1 wt %, e.g. from about 1 wt % to about 20 wt %, or at least less than about 50 wt %, e.g. from about 25 wt % to about 45 wt %, by weight of the calcined gypsum.

The gypsum slurries according to this disclosure are aqueous, meaning that they are prepared by mixing calcined gypsum and other additives with water. The slurries can be prepared in different water-to-stucco weight ratios (WSR). In some preferred embodiments the WSR may be in the range (by weight) from about 0.5 to about 1.2, and more preferably from about 0.65 to about 0.9.

In some embodiments, the gypsum slurry may be formulated with a foam which includes air bubbles such that the resulting gypsum core (12) may contain air voids (24).

In order to introduce foam into a gypsum slurry, a foaming agent can be mixed with water and air in a foam generator and then injected into a gypsum slurry, including as described in U.S. Pat. No. 5,643,510 5,683,635. Suitable foaming agents may include a foaming agent useful to generate stable foam, a foaming agent useful to generate unstable foam, or any combination thereof. Foaming agents for generating unstable foam may include an alkyl sulfate having an alkyl chain containing from 2 to 20 carbon atoms, and more preferably an alkyl sulfate having an alkyl chain from 8 to 12 carbon atoms, having the following general formula (I):
ROSO₃M, wherein R is the alkyl chain and M is a cation, e.g. sodium.

Foaming agents for generating stable foam may include sulfates comprising both an alkyl chain and an ethoxy group and having the following general formula (II):
CH₃(CH₂)ₓCH₂ (OCH₂CH₂)_{y}OSO₃M, wherein X is a number from 2 to 20 and Y is a number from 0 to 10 and is greater than 0 in at least 50 weight percent of the foaming agent.

In some embodiments, the foaming agents (I) and (II) may be blended together such that the combined portion of foaming agents without the ethoxy group is from about 80 to about 99 wt/% of the mixture.

In the embodiments wherein foam is added to the gypsum slurry, a foaming agent or a combination of foaming agents as discussed above can be used in any suitable amount to generate foam. Preferably, about 0.004 to about 0.05, and more preferably ab out 0.004 to about 0.01 wt/% of the foaming agent(s) by weight the calcined gypsum can be used. In order to generate foam, the foaming agent(s) are mixed with water and air, the resulting foam can be then mixed with a gypsum slurry.

One embodiment of a gypsum slurry according to this disclosure for preparing the gypsum core (12) is listed in Table 1 below.

TABLE 1

| Component | Workable Range¹ | | Preferred Amounts¹ | |
|---|---|---|---|---|
| Calcined Gypsum | 2.1-3.0 lbs/SF for ⅝ inch | | 2.4-2.9 lbs/SF for ⅝ inch | |
| | board | | board | |
| Glass Fibers | 0.4-1.0 | wt % | 0.4-0.5 | wt % |
| Paper Fibers | 0.4-1.0 | wt/% | 0.4-0.5 | wt % |
| Pregelatinized starch | 0.1-1.0 | wt % | 0.1-0.5 | wt % |
| Acid-modified starch | 0.1-1.0 | wt % | 0.1-0.5 | wt % |
| Siloxane (Optional) | 0.0-1.0 | wt/% | 0.1-0.5 | wt % |
| Fly ash (Optional) | 0.0-1.0 | wt % | 0.1-0.5 | wt % |
| Magnesium Oxide | 0.0-1.0 | wt % | 0.1-1.0 | wt % |
| (Optional) | | | | |
| HRA | 0.1-1.0 | wt % | 0.1-0.5 | wt % |
| Phosphate Compound | 0.0-1.0 | wt % | 0.1-0.5 | wt % |
| (Optional) | | | | |
| Calcium Chelator | 0.1-1.0 | wt % | 0.1-0.5 | wt % |
| Dispersant | 0.0-1.0 | wt % | 0.4-5.0 | wt/% |
| Biocide (Optional) | 0.0-0.1 | wt % | 0.01-0.1 | wt/% |
| Water | WSR in the range 0.5-1.2 | | WSR in the range 0.65-0.9 | |
| Foaming Agent (Optional) | 0.0-0.05 | wt % | 0.004-0.01 | wt % |

¹All wt/% by weight of the calcined gypsum

In the gypsum roof boards (10) according to this disclosure, the gypsum core (12) is covered with the facer fiber mat (14) on the first long surface (18) and with the backer fiber mat (16) of the second long surface (20).

Fiber mats (14 and 16) can comprise any suitable type of polymeric fiber, mineral fiber, or any combination thereof. The two mats (14 and 16) may be made of the same fibers or differ from each other in fiber and/or binder and/or coating compositions. Non-limiting examples of suitable fibers may include glass fibers, polyester fibers, polyamide fibers, or any combinations thereof. Preferably, fibers in the fiber mats (14) and/or (16) may include glass fibers. The fibers of the mat (14 and/or 16) can be hydrophobic or hydrophilic, coated or uncoated.

The fiber mat (14 and/or 16) can be woven or non-woven. Non-woven mats may comprise fibers bound together with a binder which in embodiments may include one or more of the following compounds: acrylate, polyvinyl acetate, urea formaldehyde, styrene acrylic co-polymer, or any combination thereof, but any other binder typically used in manufacturing of a fiber mat, can be also used.

In some preferred embodiments, the facer fiber mat (14) may be a glass fiber or synthetic fiber mat coated with a latex-based coating, while the back fiber mat (16) may be an uncoated glass fiber mat or uncoated synthetic fiber mat.

In some embodiments, the facer fiber mat (14) may be a glass fiber mat coated with a latex-based coating which comprises additives, including an inorganic filler, the inorganic filler preferably comprising calcium carbonate in at least some embodiments. The coating may fill the glass fiber mat to prevent gypsum slurry bleeding through during the gypsum roof board (10) manufacturing process.

The facer fiber mat (14) may be of various thickness, including in embodiments having a thickness ranging from about 20 to about 35 mils (about 508 to about 889 microns). The coated facer fiber mat (14) may be of various weight, including in embodiments, the facer fiber mat (14) having the composite weight ranging from about 60 to about 95 pounds per one thousand square feet (about 293 to about 464 grams per one square meter). Preferred embodiments of the facer fiber mat (14) include those, wherein the facer fiber mat (14) has a tensile strength in the machine direction of at least about 120 or more lbf/3 inches s and has a tensile strength in the cross-machine direction of at least about 90 or more lbf/3 inches. In some preferred embodiments, the facer fiber mat (14) may have a tensile strength in the machine direction of about 120 to about 200 lbf/3 inches and may have a tensile strength in the cross-machine direction of about 90 to about 120 lbf/3 inches. Preferred embodiments of the facer fiber mat (14) include those, wherein the facer fiber mat (14) has a porosity of about 8 to about 60 seconds/300 cm³, as measured by the Gurley method using a Gurley densometer.

In some preferred embodiments, the backer fiber mat (16) may be an uncoated nonwoven glass fiber mat in which glass fibers are arranged in a random pattern and bonded together with an acrylic resin binder. The binder content in the backer fiber mat (16) may be in the range from about 20 to about 30 wt %. The backer fiber mat (16) may be of various thickness, including in embodiments having the average thickness ranging from about 25 to about 35 mils. The backer fiber mat (16) may be of various composite weight, including in embodiments, the backer fiber mat (16) having the composite weight ranging from about 20 to about 30 pounds per one thousand square feet. Preferred embodiments of the backer fiber mat (16) include those, wherein the backer fiber mat (16) has a tensile strength in the machine direction of at least 120 or more lbf/3 inches and has a tensile strength in the cross-machine direction of at least 90 or more lbf/3 inches.

It has been unexpectedly found that the gypsum roof board (10) is sufficiently impact-resistant to hail damage such that these gypsum roof boards (10s) can be used in a roof deck assembly suitable for geographic locations known to have severe hailstorms.

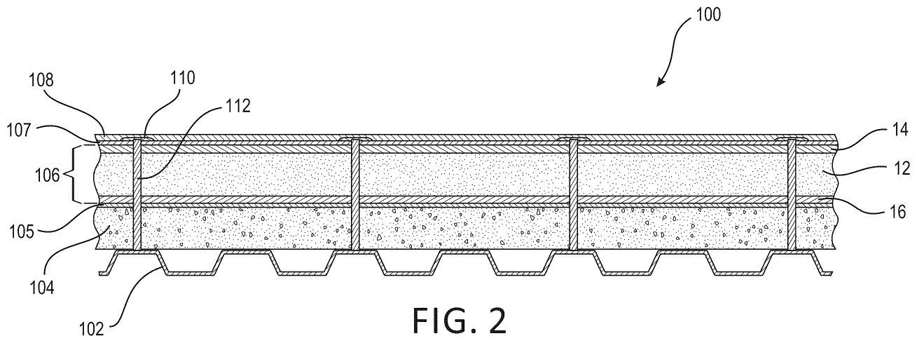

With reference to FIG. 2, a cross-sectional view of one embodiment of the roof deck is shown, generally (100). The roof deck (100) can be used in low-slope roof decks, and in particular in commercial and industrial building roofs with low-slope roof decks.

From the bottom (closest to Earth when constructed over a building) to the top, the roof deck (100) may comprise a support (102) which in embodiments may be a metal sheet, preferably a corrugated steel sheet, attached to frame members (not shown). An insulation layer (104) is disposed over the support (102). A gypsum roof layer (106) composed of abutting gypsum roof boards (10s) is built over the insulation layer (104). In embodiments, the gypsum roof boards (10s) may be secured to the insulation layer(s) (104) with an adhesive (105).

Examples of suitable insulation layer(s) (104) may include, but are not limited to, polymer-based foam insulation, including polyisocyanurate (“ISO foam”) boards which are polyisocyanurate (polyiso), closed-cell, rigid foam boards which are preferably bonded to facers on one or both sides.

A bonding between the insulation layer (104) and the gypsum roof board layer (106) may be accomplished with an adhesive (105) in embodiments. Suitable adhesives (105) may include, but are not limited to, elastomeric foamable adhesives which may be preferably a two-component, polyurethane-based adhesive, most preferably composed of polyurethane polymers, isocyanates, wherein isocyanates may include, polymethylene polyphenyl diisocyanate and/or dipehylemethane diisocyanate, and polyols.

In some embodiments, the gypsum roof boards (10s) can be attached to the insulation layer (104) with the adhesive (105) applied in a pattern, e.g. a 12-inch ribbon pattern over the surface of the insulation layer (104). In some embodiments, the gypsum roof board layer (106) may be secured to the support (102) with a set of plates (110) and fasteners (112) which may be applied at the seams of abutting gypsum roof boards forming the gypsum roof board layer (106).

A waterproof membrane, preferably a pre-made waterproof membrane (108) may be applied over the gypsum roof board layer (106). A bonding between the gypsum roof board layer (106) and a waterproof membrane (108) may be accomplished with an adhesive (107).

Various conventional waterproof membranes (108) commonly known in the field, can be used, including those described in U.S. Pat. Nos. 10,486,388 and 11,111,174. The waterproof membrane (108) prevents penetration of rain and snow onto the gypsum roof board layer (106) and below it. The waterproof membrane (108) may be composed of rubber, synthetic rubber, polyolefins and/or modified bitumen, asphalt or other materials. It has been unexpected found that the gypsum roof board (10) is sufficiently hail impact-resistant in combination with a great variety of waterproof membranes (108), including, but not limited to, membranes that are composed of one or more of the following: an ethylene propylene diene monomer (EPDM) rubber, thermoplastic polyolefin (TPO), polyvinyl chloride (PVC), and/or ketone ethylene ester (KEE). Suitable membranes (108) include those which are not reinforced, or they may be reinforced for example with a polyester scrim. Suitable membranes (108) may include, but not limited to: ethylene propylene diene monomer (EPDM) rubber membrane, thermoplastic polyolefin (TPO) membrane, polyvinyl chloride (PVC) membrane, a ketone ethylene ester (KEE) membrane reinforced with a knitted polyester fabric (scrim), polyvinyl chloride (PVC) reinforced with a polyester scrim and plasticized with Ketone Ethylene Ester (KEE) membrane, thermoplastic polyolefin (TPO) bonded to a layer of polyester scrim membrane.

The waterproof membrane (108) may be adhered to the gypsum roof board layer (106) with the adhesive (107), which may comprise one or more of the following: asphalt, epoxy, polyurethane, or any other adhesive that can be used with a particular waterproof membrane. The waterproof membrane (108) can be of any suitable thickness, preferably of dry thickness ranging from about 30 to about 100 mil, e.g. 36 mil, 45 mil, 50 mil, 60 mil, 65 mil, 70 mil, 75 mil, 80 mil, 85 mil, 90 mil or 95 mil.

In embodiments, a top cover (not shown), for example as shingles, gravel, tiles, can be then laid over and attached to the waterproof membrane (108).

Typically, the gypsum roof board (10) may be installed with the facer cover sheet (14) to be overlayed with the waterproof membrane (108), while the backer fiber mat (16) of the gypsum roof board (10) is facing the insulation layer (104).

It has been found that the gypsum roof board (10), as tested in a roof deck assembly, one embodiment of which includes the roof deck assembly (100), is hail damage resistant and may pass without cracking the FM 4470 Very Sever Hail (VSH) test which can be conducted as follows.

A two-inch (51 mm) diameter ice ball is propelled at the roof deck assembly (100) at a velocity of 152-160 f/s (46-49 m/s) from an air cannon, achieving an impact energy of 53-58 ft-lb (72-79 J) at the membrane (108) surface. In order for the gypsum roof board (10) to pass the test, no cracking or splitting should be present on the gypsum roof board (10). The cracking or splitting of the gypsum roof board (10) can be detected by visual inspection of the gypsum roof board (10), including the back facer (16) of the gypsum roof board (10) after the deck assembly (100) comprising the gypsum roof board layer (106) is subjected to impacts with the ice balls. However, minor surface indentations on the waterproof membrane (108) at the point of impact are acceptable. The ice balls for these tests can be prepared in accordance with the ANSI FM 4473 standard. Roof surface temperature shall be 40-45° F. (4-7° C.). All samples are subjected to a minimum of three ice ball impacts, as noted in Table 2 below.

These tests can be performed with roof deck assemblies which are unconditioned and also with roof deck assemblies that have been conditioned (weathered, aged) for 1000 hours in an ultraviolet weathering cabinet and/or a roof deck assembly can be heat aged. For heat aging, non-asphaltic membranes may be heated to 240±5° F. (116±3° C.) for 1000 hours, while asphaltic membranes may be heated to 160±5° F. (71±3° C.) for 1000 hours.

All roof deck samples are subjected to a minimum of three ice ball impacts, as noted in Table 2 below. In Table 2, “the substrate” refers to an insulation layer and the roof cover refers to the gypsum roof board over which a waterproof membrane is applied.

TABLE 2

| Roof Deck Sample | Impact Locations |
|---|---|
| Fully adhered roof cover over | 1 - field-fabricated seam |
| mechanically fastened substrate | 1 - field of roof cover |
| | 1 - fastener/stress plate |
| Fully adhered roof cover over fully adhered | 1 - field-fabricated seam |
| substrate | 2 - field of roof cover |
| Fully adhered roof cover over partially | 1 - field-fabricated seam |
| adhered (ribbon applied) substrate | 1 - field of roof cover directly over ribbon |
| | 1 - field of roof cover between ribbons |
| Partially adhered roof cover over fully | 1 - field-fabricated seam |
| adhered substrate | 1 - field of roof cover directly over ribbon |
| | 1 - field of roof cover between ribbons |
| Partially adhered roof cover over partially | 1 - field-fabricated seam |
| adhered (ribbon applied) substrate | 1 - field of roof cover directly over ribbon |
| | 1 - field of roof cover between ribbons |
| Mechanically fastened roof cover over | 1 - field-fabricated seam |
| loose laid substrate | 1 - field of roof cover |
| | 1 - fastener/stress plate |
| All other assemblies | Minimum of three impacts at critical |
| | locations as determined by engineer. |

It has been unexpectedly found that the gypsum roof panel according to this disclosure may comply with the FM 4470 VSH standard. The gypsum roof panel according to this disclosure may further comply with the Factory Mutual's moderate hail (MH) rating and/or severe hail (SH) rating in accordance with FM 4470, which can be tested as follows.

The minimum rating required for certification is Class 1-MH. For MH and SH, two identical samples are prepared with the roof cover applied to the selected substrate.

The first sample is unconditioned and tested as follows:
1. The sample is subjected to a minimum of ten impacts from the 1.19 lb (1 kg) steel ball.
2. For SH, the ball is dropped from a height of 141.5 in. (3595 mm), generating an impact energy of approximately 14 ft-lb (19 J).
3. For MH, the ball is dropped from a height of 81 in. (2057 mm), generating an impact energy of approximately 8 ft-lb (10.8 J). The second sample is conditioned (weathered) for 1000 hours in an Ultraviolet Weathering Cabinet. The sample is then subjected to impact testing as described above.

In another aspect, this disclosure relates to methods for manufacturing the gypsum roof board (10). In embodiments, the gypsum roof board may be manufactured on a moving conveyor. A gypsum slurry is mixed from calcined gypsum, water and other additives in a mixer, an embodiment of which may include those described in U.S. Pat. Nos. 6,494,609 and 6,874,930. If a gypsum slurry is to be prepared with foam, then foam is added from a foam generator. From a mixing chamber of the mixer, the gypsum slurry is then released through a discharge conduit onto the facer fiber mat (14) fed from a roll on a continuously moving conveyor. The deposited gypsum slurry is then covered with the backer fiber mat (16) fed from a roll. This forming ribbon (gypsum board precursor) is allowed to continue moving on the conveyor until the gypsum board precursor is sufficiently set in order to be cut into gypsum roof boards, wherein cutting is in the cross-machine direction (along the width (W) axis). Gypsum boards are then moved into to a kiln for drying, wherein the gypsum boards are dried at an elevated temperature, preferably in the range from about 650° F. to about 700° F. In some embodiments, the gypsum boards may be dried in a dual-temperature kiln, wherein the gypsum board is dried in a first kiln zone operated at a temperature ranging from about 650° F. to about 700° F., and then the gypsum board is moved to a second kiln zone, wherein the gypsum board is dried at a temperature ranging from about 200° F. to about 270° F. A drying temperature range in a kiln may be adjusted as needed, depending on a conveyor speed, kiln design, gypsum roof board density, and/or facers used.

The gypsum roof boards according to this disclosure may be used in various building construction assemblies, including, but not limited to, roof decks.

The following non-limiting example exemplifies the gypsum roof boards, roof decks and testing methods according to this disclosure.

### Example 1

Gypsum roof boards were prepared from a gypsum slurry formulated according to Table 1, by extruding the gypsum slurry between a facer fiber mat and a backer fiber mat. In embodiments where the gypsum slurry was foamed, an adhesive layer composed of the same gypsum slurry without foam was first disposed over the facer fiber mat prior to deposing the foamed slurry.

Sample roof deck assemblies were built as listed in Table 3 and tested for impact resistance with a 2-inch ice ball in accordance with the FM 4473 VSH test. All roof deck assemblies included an ISO foam board as the insulation layer.

TABLE 3

| Foam Board | | | | FM4470 |
|---|---|---|---|---|
| Adhesive | Membrane Adhesive | Membrane | Sample | VSH Test |
| A dual- | Alpha Tite Bonding | 50-mil of | 5B/5C | Pass |
| component | Adhesive (alpha- | FiberTite-XT | | |
| polyurethane | cyanoacrylate and a | (a ketone | | |
| Adhesive | hydrophobic silica | ethylene ester | | |
| 12″ Ribbons | surface-treated with | (KEE) | | |
| | dimethyldichlorosilane) | membrane | | |
| | | reinforced | | |
| | | with a knitted | | |
| | | polyester | | |
| | | fabric) | | |
| A dual- | EverGuard #2331 | 60-mil | 6A/B | Pass |
| component | Bonding Adhesive (a | EverGuard | | |
| polyurethane | contact -type bonding | PVC KEE | | |
| Adhesive | adhesive designed for | (polyvinyl | | |
| 12″ Ribbons | bonding PVC roofing | chloride | | |
| | membranes) | (PVC) | | |
| | | reinforced | | |
| | | with a | | |
| | | polyester | | |
| | | scrim and | | |
| | | plasticized | | |
| | | with Ketone | | |
| | | Ethylene Ester | | |
| | | (KEE)) | | |
| | | 80-mil | 7A/B | Pass |
| | | EverGuard | | |
| | | PVC | | |
| | | (polyvinyl | | |
| | | chloride | | |
| | | (PVC) resin | | |
| | | which also | | |
| | | includes | | |
| | | additives such | | |
| | | as phthalate | | |
| | | esters and | | |
| | | calcium | | |
| | | carbonate) | | |
| | EverGuard TPO 1121 | 60-mil | 8A/B | Pass |
| | Bonding Adhesive (a | EverGuard | | |
| | solvent-based | TPO | | |
| | rubberized adhesive | (thermoplastic | | |
| | designed for use with | polyolefin | | |
| | TPO-based | bonded to a | | |
| | membranes) | layer of | | |
| | | polyester | | |
| | | scrim in the | | |
| | | middle) | | |
| A dual- | Sure-Seal 90-8-30A (a | 90-mil | 9A/B | Pass |
| component | high-strength, solvent- | Sure-Seal FR | | |
| polyurethane | based contact adhesive | Nonreinforced | | |
| Adhesive | primarily composed | (synthetic | | |
| 12″ Ribbons | of synthetic rubber, | rubber) | | |
| | with a solvent base | | | |
| | containing petroleum | | | |
| | distillates, toluene, | | | |
| | acetone, xylenes, and | | | |
| | other components like | | | |
| | polychloroprene, | | | |
| | phenolic resin, and | | | |
| | magnesium oxide) | | | |
| | Sure-Seal 90-8-30A (is | 60-mil Sure- | 10A/B | Pass |
| | a high-strength, | Weld | | |
| | solvent-based contact | (thermoplastic | | |
| | adhesive primarily | polyolefin | | |
| | composed of synthetic | (TPO) based | | |
| | rubber, with a solvent | roofing | | |
| | base containing | membrane | | |
| | petroleum distillates, | that may | | |
| | toluene, acetone, | include a | | |
| | xylenes, and other | polyester | | |
| | components like | reinforcement | | |
| | polychloroprene, | layer | | |
| | phenolic resin, and | | | |
| | magnesium oxide. | | | |
| A dual- | Alpha-Tite Adhesive (a | 36-mil | 11A/B | Pass |
| component | solvent-based contact | FiberTite-XT | | |
| polyurethane | adhesive for use with a | (a ketone | | |
| Adhesive | ketone ethylene ester | ethylene ester | | |
| 12″ Ribbons | (KEE) membrane) | (KEE) | | |
| | | membrane | | |
| | | reinforced | | |
| | | with a knitted | | |
| | | polyester | | |
| | | fabric) | | |
| A dual- | Sarnacol 2170 (a | 60-mil S327 | 12A/B | Pass |
| component | solvent-based, | (PVC | | |
| polyurethane | reactivating adhesive | membrane | | |
| Adhesive | primarily composed | which | | |
| 12″ Ribbons | of nitrile rubber and | contains | | |
| | solvents like ethyl | ultraviolet | | |
| | acetate, butanone, and | light | | |
| | toluene). | stabilizers, | | |
| | | flame | | |
| | | retardant and | | |
| | | polyester | | |
| | | scrim | | |
| | | reinforcement) | | |

All assemblies included the use of ISO foam board (1.5″ ACFoam-II)
*NOTE:
“A” specimens were not UV or heat exposed. “B” specimens were post-UV exposure. “C” specimens were post-UV and also post-heat exposure (non-asphaltic membranes were heated to 240 ± 5° F. (116 ± 3° C.) for 1000 hours; and asphaltic membranes were heated to 160 ± 5° F. (71 ± 3° C.) for 1000 hours)

Based on the data shown in Table 3, it has been determined that the gypsum roof board according to this disclosure is VSH rated in application with various membranes including membranes which are reinforced with polyester scrim or not reinforced with polyester scrim.

What is claimed is:

1. A gypsum roof board for use in a roof deck,
wherein the gypsum roof board has a length, width and thickness, two long surfaces, a first long surface and a second long surface which is opposite to the first long surface,
wherein the gypsum roof board comprises a gypsum core covered on the first long surface with a facer fiber mat, said gypsum core further covered on the second long surface with a backer fiber mat,
wherein the gypsum roof board weighs at least about 2.9 pounds per square foot (lbs/SF) when the gypsum roof board has the thickness of ⅝ inch; and
wherein the gypsum core comprises a set gypsum matrix into which paper fibers and glass fibers are embedded.

2. The gypsum roof board of claim 1, wherein the gypsum core does not comprise fiberglass scrim and wherein the gypsum roof board is moderate hail (MH) rated, severe hail (SH) rated and/or very severe hail (VSH) rated, each rating in accordance with FM 4470.

3. The gypsum roof board of claim 1, wherein the gypsum roof board weighs about 3-4 lbs/SF when the gypsum roof board has the thickness of ⅝ inch.

4. The gypsum roof board of claim 1, wherein the gypsum roof board withstands without cracking an impact with impact energy of 53-58 feet per pound (72-79 J) applied to a surface of a roof deck containing the gypsum roof board.

5. The gypsum roof board of claim 4, wherein the impact is caused by propelling at the surface a preformed 2-inch (51 mm) diameter ice ball, wherein the ice ball is propelled with a velocity of 152 to 160 feet per second.

6. The gypsum roof board of claim 1, wherein the gypsum core is formed from an aqueous gypsum slurry comprising:
calcined gypsum in an amount ranging 2.1-3.0 lbs/SF for a ⅝ inch thick gypsum roof board;
glass fibers in an amount of 0.4-1.0 wt/% by weight of the calcined gypsum;
paper fibers in an amount of 0.4-1.0 wt/% by weight of the calcined gypsum;
pregelatinized starch in an amount of 0.1-1.0 wt % by weight of the calcined gypsum;
acid-modified starch in an amount of 0.1-1.0 wt % by weight of the calcined gypsum;
an activator comprising ground calcium sulfate dihydrate in an amount of 0.1-1.0 wt % by weight of the calcined gypsum;
one or more of the following compounds: diethylenetriamine pentaacetic acid (DTPA), citric acid, sodium citrate, potassium bitartrate, or any combination thereof in an amount of 0.01-0.5 wt % by weight of the calcined gypsum;
wherein the gypsum slurry further comprises water; and
wherein a water-to-stucco weight ratio (WSR) in the gypsum slurry is in the range from 0.5 to 1.2.

7. The gypsum roof board of claim 6, wherein the gypsum slurry further comprises fluid polymerizable siloxane, and one or more of the following compounds: fly ash, Magnesium Oxide or any combination thereof.

8. The gypsum roof board of claim 6, wherein the gypsum slurry further comprises:
a phosphate compound;
a buffering agent;
a biocide; and/or
a polycarboxylic dispersant, sulfonate dispersant, or a combination of the polycarboxylic dispersant and sulfonate dispersant.

9. The gypsum roof board of claim 6, wherein the gypsum slurry is foamed with foam comprising a combination of first foaming agent and a second foaming agent, wherein
the first foaming agent has the following formula: 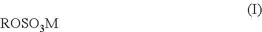
Wherein R is an alkyl chain having from 2 to 20 carbon atoms and M is a cation; and
the second foaming agent having the following formula: 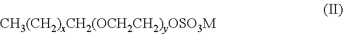
X is a number from 2 to 20, and Y is a number from 0 to 10 and is greater than 0 in at least 50 weight percent of the second foaming agent.

10. The gypsum roof board of claim 1, wherein the gypsum core contains air voids and/or wherein paper fibers comprise old corrugated container (OCC) paper fibers.

11. The gypsum roof board of claim 1, wherein the length value is equal to the width value.

12. The gypsum roof board of claim 1, wherein the gypsum roof board further comprises an adhesive layer on the first long surface, the adhesive layer positioned between the facer fiber mat and the gypsum core, wherein the adhesive layer is formed from a gypsum slurry which is not mixed with foam.

13. The gypsum roof board of claim 1, wherein the facer fiber mat is a coated glass fiber mat and/or the backer fiber mat is an uncoated glass fiber mat.

14. A roof deck assembly comprising the gypsum roof board of claim 1, the roof deck having the gypsum roof board with the second long surface being attached to an insulation layer and the gypsum roof board overlayed on the first long surface with a waterproof membrane, wherein the gypsum roof board in the roof deck withstands without cracking on the second long surface an impact with impact energy of 53-58 feet per pound (72-79 J) applied to a waterproof membrane surface of the roof deck.

15. The roof deck assembly of claim 14, wherein the waterproof membrane comprises an ethylene propylene diene monomer (EPDM) rubber membrane, thermoplastic polyolefin (TPO) membrane, polyvinyl chloride (PVC) membrane, ketone ethylene ester (KEE) membrane, or any combination thereof.

16. The roof deck assembly of claim 14, wherein the gypsum roof board is moderate hail (MH) rated, severe hail (SH) rated and/or very severe hail (VSH) rated, each rating in accordance with FM 4470.

17. The roof deck assembly of claim 15, wherein the waterproof membrane comprises a polyester scrim.

18. The roof deck assembly of claim 14, wherein:
the insulation layer composed of a polyisocyanurate rigid foam boards;
the insulation layer is bonded to the gypsum roof board with a polyurethane-based adhesive; and/or
the waterproof membrane is adhered to the gypsum roof board with asphalt, epoxy, or polyurethane adhesive.

19. The roof deck assembly of claim 14, wherein the waterproof membrane has a thickness from 30 to 100 mils.

20. A method of manufacturing the gypsum roof board of claim 1, wherein the method comprises:
a) mixing a gypsum slurry comprising at least:
calcined gypsum in an amount ranging 2.1-3.0 lbs/SF for a ⅝ inch thick gypsum roof board;
glass fibers in an amount of 0.4-1.0 wt/% by weight of the calcined gypsum;
paper fibers in an amount of 0.4-1.0 wt/% by weight of the calcined gypsum;
pregelatinized starch in an amount of 0.1-1.0 wt % by weight of the calcined gypsum;
acid-modified starch in an amount of 0.1-1.0 wt % by weight of the calcined gypsum;
an activator comprising ground calcium sulfate dihydrate in an amount of 0.1-1.0 wt % by weight of the calcined gypsum;
one or more of the following compounds: diethylenetriamine pentaacetic acid (DTPA), citric acid, sodium citrate, potassium bitartrate, or any combination thereof in an amount of 0.01-0.5 wt % by weight of the calcined gypsum; and
wherein the gypsum slurry further comprises water; and
wherein a water-to-stucco weight ratio (WSR) in the gypsum slurry is in the range from 0.5 to 1.2;
b) depositing the gypsum slurry on the facer fiber mat;
covering the deposited gypsum slurry with the backer fiber mat to form a gypsum roof board precursor;
c) cutting the gypsum roof board precursor into gypsum roof boards; and
d) drying the gypsum roof boards of step c) in kiln; and
e) optionally, cutting each gypsum roof board of step g) into two gypsum roof boards.
